(19) United States
(12) Patent Application Publication
(10) Pub. No.: US 2013/0339331 A1
(43) Pub. Date: Dec. 19, 2013

(54) TRACKING FILE CONTENT ORIGINALITY

(71) Applicant: Sharan J. Patel, Raleigh, NC (US)

(72) Inventor: Sharan J. Patel, Raleigh, NC (US)

(73) Assignee: INTERNATIONAL BUSINESS MACHINES CORPORATION, Armonk, NY (US)

(21) Appl. No.: 13/495,739

(22) Filed: Jun. 13, 2012

(51) Int. Cl. G06F 17/30

(52) U.S. Cl. 707/705; 707/E17.01

(57) ABSTRACT

Methods and systems may provide for detecting a copy operation with respect to content in a first electronic file, detecting a paste operation with respect to the content in a second electronic file, and conducting an automatic write of one or more attributes associated with the first electronic file to the second electronic file in response to the paste operation. In one example, the automatic write bypasses a user interface associated with the paste operation.

### BACKGROUND

Embodiments of the present invention generally relate to electronic files. More particularly, embodiments relate to the tracking and verification of file content originality.

Word processing applications may permit the copying/cutting of content from one document and the pasting of that content into another document, wherein the documents may have been authored by different individuals. Certain usage scenarios, however, may require documents to represent the original work of the author due to copyrighting and/or plagiarism concerns.

### BRIEF SUMMARY

Embodiments may include a computer program product having a computer readable storage medium and computer usable code stored on the computer readable storage medium. If executed by a processor, the computer usable code may cause a computer to detect a copy operation with respect to content in a first electronic file, and detect a paste operation with respect to the content in a second electronic file. The computer usable code, if executed, may also cause a computer to conduct an automatic write of one or more attributes associated with the first electronic file to the second electronic file in response to the paste operation.

Embodiments can also include a computer implemented method in which a copy operation is detected with respect to content in a first electronic file, and a paste operation is detected with respect to the content in a second electronic file. The method may also provide for conducting an automatic write of one or more attributes associated with the first electronic file to the second electronic file in response to the paste operation, wherein the automatic write sets a file system metadata value in the second electronic file, marks the one or more attributes in the second electronic file as read only, and bypasses a user interface associated with the paste operation. Additionally, a file open request may be received with respect to the second electronic file, wherein the record electronic file may be opened in response to the open file request and a content originality message may be generated based on the one or more attributes. In one example, the content originality message identifies the first electronic file as a source of the content.

Embodiments may include a computer program product having a computer readable storage medium and computer usable code stored on the computer readable storage medium. If executed by a processor, the computer usable code may cause a computer to detect a copy operation with respect to content in a first electronic file, and detect a paste operation with respect to the content in a second electronic file. The computer usable code, if executed, can also cause a computer to conduct an automatic write of one or more attributes associated with the first electronic file to the second electronic file in response to the paste operation, wherein the automatic write is to set a file system metadata value in the second electronic file, mark the one or more attributes in the second electronic file as read only, and bypass a user interface associated with the paste operation. Additionally, the computer usable code, if executed, may cause a computer to receive a file open request with respect to the second electronic file, open the second electronic file in response to the open file request, and generate a content originality message based on the one or more attributes. In one example, the content originality message may identify the first electronic file as a source of the content.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a block diagram of an example of an automatic write of one or more file attributes to an electronic file according to an embodiment;

FIG. 2 is a flowchart of an example of a method of conducting an automatic write of one or more file attributes to an electronic file according to an embodiment;

FIG. 3 is a flowchart of an example of a method of processing a file open request according to an embodiment;

FIG. 4 is a block diagram of an example of a content originality message according to an embodiment; and

FIG. 5 is a block diagram of a computing system according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

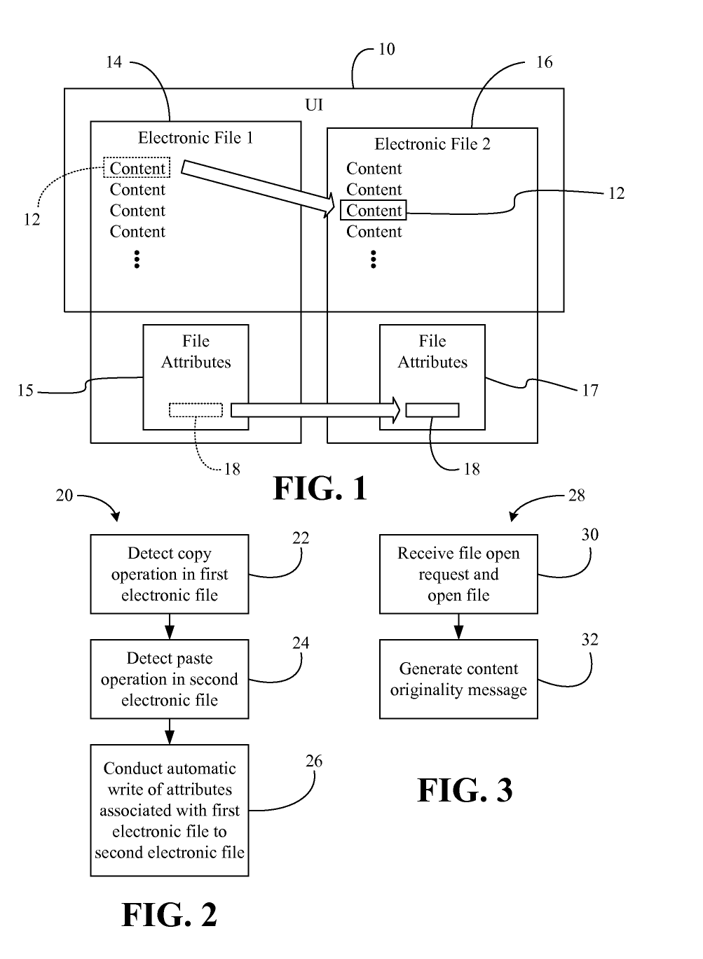

Referring now to FIG. 1, a user interface (UI) 10 is shown in which content 12 may be copied from a first electronic file (“Electronic File 1”) 14 and pasted into a second electronic file (“Electronic File 2”) 16, wherein the illustrated electronic files 14, 16 have corresponding file attributes 15, 17, respectively. The electronic files 14, 16 may be, for example, word processing documents (e.g., Word, OpenOffice or Google Docs files) or source code files (e.g., Java, Smalltalk, C++, or “C” language files) in which verification of the originality of the content in at least the second electronic file 16 is necessary for copyright and/or plagiarism reasons. In the illustrated example, pasting the content 12 into the second electronic file 16 causes one or more attributes 18 associated with the first electronic file 14 to be automatically written to the second electronic file 16. The attributes 18 may include, for example, a file name and/or directory location corresponding to the first electronic file 14. Of particular note is that the automatic write of the attributes 18 bypasses the user interface 10 associated with the paste operation, in the example shown. Accordingly, the individual copying the content 12 may be prevented from being made aware of the attribute transfer. As a result, unauthorized and potentially illegal copying of content can be tracked without the knowledge of or tampering by the individual doing the copying.

FIG. 2 shows a method 20 of conducting an automatic write of one or more file attributes to an electronic file. The method 20 may be implemented in an application such as, for example, a word processing or source code authoring program, wherein the application might be executed on a desktop computer, notebook computer, smart tablet, and so forth. Illustrated processing block 22 provides for detecting a copy operation with respect to content in a first electronic file, wherein a paste operation may be detected with respect to the copied content in a second file at block 24. Block 26 may conduct an automatic write of one or more attributes associated with the first electronic file to the second electronic file in response to the paste operation. In one example, the copy operation may trigger a capture and storage of the attributes to a temporary memory location, wherein the paste operation triggers a transfer of the attributes from the temporary memory location to a persistent memory location associated with the second electronic file.

More particularly, the automatic write could involve setting a file system metadata value such as a UNIX based inode attribute of the second electronic file according to the file attributes of the first electronic file. In addition, the attributes may be marked in the second electronic file as read only in order to prevent tampering. As already noted, the automatic copy can bypass the user interface associated with the paste operation to further ensure content originality.

Turning now to FIG. 3, a method 28 of processing a file open request is shown. The method 28 may also be implemented in an application such as, for example, a word processing or source code authoring program. Illustrated block 30 provides for receiving the file open request and opening an electronic file in response to the request, wherein a content originality message may be generated at block 32 based on one or more file attributes in response to the file open request.

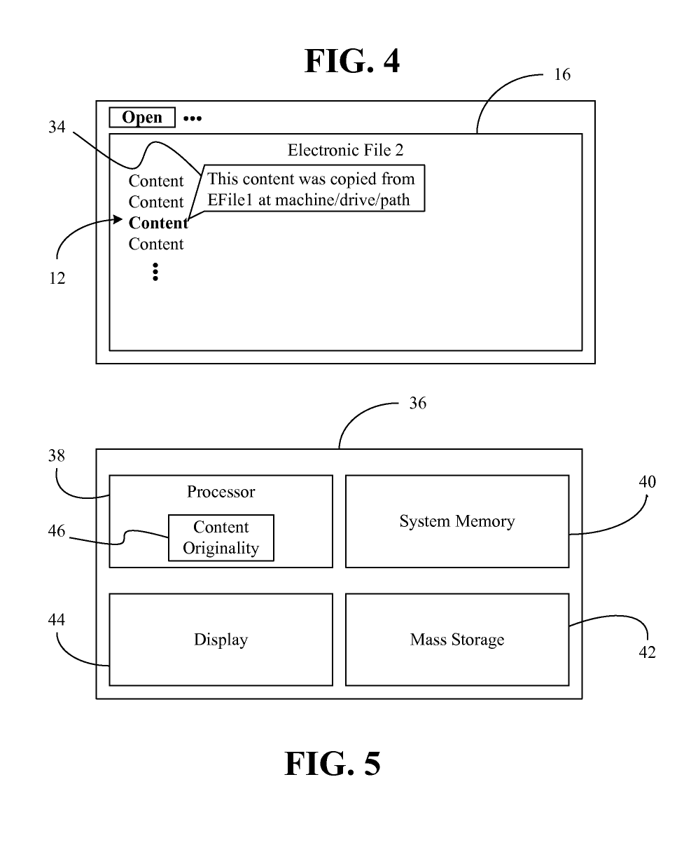

FIG. 4 demonstrates that a content originality message 34 might be generated for the aforementioned content 12 in the second electronic file 16. In the illustrated example, the content originality message 34 identifies the first electronic file 14 (FIG. 1) as the source of the content 12 (e.g., “This content was copied from EFile1 at machine/drive/path”). Thus, the illustrated content originality message 34 specifies the file name as well as the directory location of the source of the content 12. Other attributes of the source file such as author name, copy date, paste date, etc., may also be incorporated into the message 34. The content originality message 34 could be generated either directly in response to the file open request or indirectly based on a mouse over action with respect to the content 12, wherein the content 12 may be given a different visual appearance (e.g., bold, highlight, etc.) due to the existence of attribute data related to content originality.

FIG. 5 shows a computing system 36 that may be used to track content originality. The illustrated system 36 includes a processor 38, system memory 40 (e.g., volatile memory), mass storage 42 (e.g., non-volatile memory/NVM), and a display 44. The processor 38 may execute content originality logic 46 that is configured to detect a copy operation with respect to content in a first electronic file, detect a paste operation with respect to the content in a second electronic file, and conduct an automatic write of one or more attributes associated with the first electronic file to the second electronic file in response to the paste operation, as already discussed. In one example, the automatic write sets a file system metadata value in the second electronic file, marks the one or more attributes in the second electronic file as read only, and bypasses a user interface associated with the paste operation.

Techniques described herein may therefore enable authors of books, papers, essays, software code, and so forth, to ensure that their credentials follow their work in an environment in which copying and pasting is prevalent. Indeed, tracing the contents of an electronic file to its point(s) of origin can be particularly advantageous in a wide variety of settings.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
detecting a copy operation with respect to content in a first electronic file;
detecting a paste operation with respect to the content in a second electronic file;
conducting an automatic write of one or more attributes associated with the first electronic file to the second electronic file in response to the paste operation, wherein the automatic write sets a file system metadata value in the second electronic file, marks the one or more attributes in the second electronic file as read only, and bypasses a user interface associated with the paste operation;
receiving a file open request with respect to the second electronic file; and
opening the second electronic file in response to the file open request;
generating a content originality message based on the one or more attributes, wherein the content originality message identifies the first electronic file as a source of the content.

2. The method of claim 1, wherein at least one of the one or more attributes includes a file name.

3. The method of claim 1, wherein at least one of the one or more attributes includes a directory location.

4. The method of claim 1, wherein one or more of the first and second electronic files includes a word processing document.

5. The method of claim 1, wherein one or more of the first and second electronic files includes a source code file.

6. A computer program product comprising:
a computer readable storage medium; and
computer usable code stored on the computer readable storage medium, where, if executed by a processor, the computer usable code causes a first device to:
detect a copy operation with respect to content in a first electronic file;
detect a paste operation with respect to the content in a second electronic file;
conduct an automatic write of one or more attributes associated with the first electronic file to the second electronic file in response to the paste operation, wherein the automatic write is to set a file system metadata value in the second electronic file, mark the one or more attributes in the second electronic file as read only, and bypass a user interface associated with the paste operation;
receive a file open request with respect to the second electronic file; and
open the second electronic file in response to the open file request;
generate a content originality message based on the one or more attributes, wherein the content originality message is to identify the first electronic file as a source of the content.

7. The computer program product of claim 6, wherein at least one of the one or more attributes is to include a file name.

8. The computer program product of claim 6, wherein at least one of the one or more attributes is to include a directory location.

9. The computer program product of claim 6, wherein one or more of the first and second electronic files is to include a word processing document.

10. The computer program product of claim 6, wherein one or more of the first and second electronic files is to include a source code file.

11. A computer program product comprising:
a computer readable storage medium; and
computer usable code stored on the computer readable storage medium, where, if executed by a processor, the computer usable code causes a computer to:
detect a copy operation with respect to content in a first electronic file;
detect a paste operation with respect to the content in a second electronic file; and
conduct an automatic write of one or more attributes associated with the first electronic file to the second electronic file in response to the paste operation.

12. The computer program product of claim 11, wherein the automatic write is to bypass a user interface associated with the paste operation.

13. The computer program product of claim 11, wherein the computer usable code, if executed, causes a computer to mark the one or more attributes in the second electronic file as read only.

14. The computer program product of claim 11, wherein the computer usable code, if executed, causes a computer to set a file system metadata value in the second electronic file to conduct the automatic write.

15. The computer program product of claim 11, wherein the computer usable code, if executed, causes a computer to:
receive a file open request with respect to the second electronic file; and
open the second electronic file in response to the open file request;
generate a content originality message based on the one or more attributes.

16. The computer program product of claim 15, wherein the content originality message is to identify the first electronic file as a source of the content.

17. The computer program product of claim 11, wherein at least one of the one or more attributes is to include a file name.

18. The computer program product of claim 11, wherein at least one of the one or more attributes is to include a directory location.

19. The computer program product of claim 11, wherein one or more of the first and second electronic files is to include a word processing document.

20. The computer program product of claim 11, wherein one or more of the first and second electronic files is to include a source code file.
